(19) United States
(12) Patent Application Publication
(10) Pub. No.: US 2026/0313442 A1
(43) Pub. Date: Oct. 8, 2026

(54) SIGNALING AND DETERMINING DATA BOOST INFORMATION IN PACKET HEADER EXTENSIONS

(71) Applicant: QUALCOMM Incorporated, San Diego, CA (US)

(72) Inventors: Liangping Ma, San Diego, CA (US); Imed Bouazizi, Celina, TX (US); Hyun Yong Lee, San Diego, CA (US); Sebastian Speicher, Wallisellen (CH); Sitaramanjaneyulu Kanamarlapudi, San Diego, CA (US)

(21) Appl. No.: 19/577,021

(22) Filed: Mar. 24, 2026

Related U.S. Application Data
(60) Provisional application No. 63/783,758, filed on Apr. 4, 2025.

(51) Int. Cl. H04W 28/02; H04L 65/65; H04W 24/08; H04W 80/06

(52) U.S. Cl. CPC H04W 28/0268; H04L 65/65; H04W 24/08; H04W 80/06

(57) ABSTRACT

An example device for exchanging (e.g., sending and/or receiving) data via a network includes a memory configured to store the data; and a processing system comprising one or more processors implemented in circuitry, the processing system being configured to exchange a packet of a media communication session, the packet including a packet header extension, the packet header extension including target bitrate data for the media communication session. The packet header extension may be, for example, a real-time transport protocol (RTP) header extension or a QUIC header extension. The processing system may be configured to negotiate the use of the packet header extension, e.g., in session description protocol (SDP) messages, or in-band for QUIC, e.g., using negotiation frames of QUIC.

This application claims the benefit of U.S. Provisional Application No. 63/783,758, filed Apr. 4, 2025, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging data via a network, such as media data. The network may include a radio access network (RAN), such as a 5G network. In particular, a media application server (AS) device or a media application provider (AP) device may send media data to a client device (e.g., a user equipment (UE) device) via a network tunnel coupled to the RAN, e.g., at a base station (such as a gNodeB). In particular, a user plane function (UPF) device may serve as an ingress point to the network tunnel, and a server device may send the media data to the UPF device to reach the UE device. In some cases, administrators of the server device may wish to improve a bitrate for a media communication session between the server device and the UE device. To do so, per techniques of this disclosure, the server device and the UPF device, among other devices involved in the media communications session, may exchange desired Quality of Service (QoS), which may include any or all of a desired bitrate, a desired delay, and/or a desired packet loss rate for the media communication session. The devices may use this data to monitor actual QoS for the media communication session, compare the actual QoS to the desired QoS, and indicate to the network to make changes to satisfy the desired QoS (e.g., send feedback data to the network).

In one example, a method of receiving data via a network includes: extracting data representing quality of service (QoS) requirements for a packet of a media communication session from a packet header extension of the packet; monitoring at least one performance metric of the media communication session based on the QoS requirements to determine a monitored performance metric; comparing the monitored performance metric to the QoS requirements to generate feedback data; and sending the feedback data to a source device that sent the packet as part of the media communication session.

In another example, a device for receiving data via a network includes: a memory configured to store data; and a processing system implemented in circuitry and configured to: extract data representing quality of service (QoS) requirements for a packet of a media communication session from a packet header extension of the packet; monitor at least one performance metric of the media communication session based on the QoS requirements to determine a monitored performance metric; compare the monitored performance metric to the QoS requirements to generate feedback data; and send the feedback data to a source device that sent the packet as part of the media communication session.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a block diagram illustrating an example set of network devices that may perform various aspects of the techniques of this disclosure.

FIG. 4 is a conceptual diagram illustrating an example real-time transport protocol (RTP) packet including an RTP header extension per techniques of this disclosure.

FIGS. 5A and 5B are conceptual diagrams illustrating examples of RTP header extensions per techniques of this disclosure.

FIGS. 6A and 6B are conceptual diagrams illustrating additional examples of RTP header extensions per techniques of this disclosure.

FIG. 7 is a conceptual diagram illustrating an example of use of QUIC packets including QUIC header extensions including data boosting indication information per techniques of this disclosure.

FIG. 8 is a conceptual diagram illustrating an example QUIC packet per techniques of this disclosure.

FIG. 9 is a call flow diagram illustrating an example method for negotiating use of QUIC header extensions per techniques of this disclosure.

FIG. 10 is a flowchart illustrating an example method of improving quality of service (QoS) of a media communication session per techniques of this disclosure.

### DETAILED DESCRIPTION

In general, this disclosure describes techniques for transmitting data via a network, such as a radio access network (RAN). In some techniques, a data burst is defined as a set of multiple protocol data units (PDUs) generated and sent by an application such that there is an idle period between two data bursts. A data burst can include one or more PDU Sets. A PDU Set may include one or more PDUs carrying payload data for a common unit of information generated at the application level (e.g., video frames, video slices, metadata, or the like).

Various protocols may be used to send and receive media data of a media communication session. Real-time transport protocol (RTP) is one example of such a protocol for exchanging media data. While RTP is often used to transfer media data via a network, another transmission protocol is QUIC, per Iyengar et al., “QUIC: A UDP-Based Multiplexed and Secure Transport,” Internet Engineering Task Force (IETF), RFC 9000, May 2021, available at datatracker.ietf.org/doc/html/rfc9000.

In general, QUIC provides fast connection setup, good support for mobility (e.g., using connection migration), mitigation of head-of-line blocking, and native support for encryption (e.g., transport layer security (TLS)). However, QUIC packets do not conventionally directly expose application layer information that can be used for cross-layer optimization. Also, QUIC packet headers are generally encrypted except for a few fields, such as a version field, a connection ID, and a spin bit.

In general, packet header extensions, per techniques of this disclosure, may be used to signal a requested data boost from application layer data, in order to expose the requested data boost to a network (e.g., network devices forming the network). For example, an application server may send a data boosting indicator in a packet header extension, such as an RTP header extension.

For 5G networks or other radio access networks (RANs), a quality of service (QoS) indicator may be used for data boosting. For example, in a 5G network, a 5G QoS Identifier (5QI) may be used to define QoS for a QoS packet flow. Different 5QIs may be used to identify different QoSs. Thus, a particular 5QI may be associated with data boosting. For example, before data boosting is applied, application traffic for a media communication session may be transmitted with a certain 5QI (e.g., 20 ms packet delay budget (PDB)). After data boosting has been received, e.g., by a user plane function (UPF) device, the UPF device may move the application traffic into a QoS Flow with a high performance 5QI (e.g., 5 ms PDB).

This disclosure describes techniques for signaling and determining data boost indication data, e.g., data on desired Quality of Service including any or all of bitrate, delay (one-way, or round-trip time), and/or desired packet loss rate. In this manner, this disclosure describes techniques for indicating that data boosting is desired/needed, and if so, desired QoS information, along with techniques by which a 5G network (or other RAN) device may use such information. Such data may be signaled in a packet header extension, such as an RTP header extension or a QUIC header extension. The desired bitrate data may include, for example, an actual desired bitrate for a media communication session, a desired change to the current bitrate, a desired change in delay (e.g., an absolute change, a relative change, or a desired delay value), a desired packet error rate, and/or a traffic direction to which the indication is applicable (e.g., sending direction only, receiving direction only, or both sending and receiving directions). In this manner, devices involved in a media communication session may monitor actual bitrate conditions and make changes to effect the desired bitrate.

This disclosure further describes fundamental differences between bitrate and delay. For example, a network entity (such as a router, a UPF device, or a gNB) can observe and average bitrate locally over a relatively long time period to deduce end-to-end bitrate. However, a network entity cannot rely on local observation to reduce end-to-end delay. Increasing bitrate for a link may increase end-to-end bitrate only if that link is a bottleneck of an end-to-end path. By contrast, reducing delay on any link will lead to reduced end-to-end delay. Therefore, a traffic source may, per techniques of this disclosure, signal data indicating a request for boosting bitrate and the delay and by how much. Per techniques of this disclosure, a server device (e.g., a media application server (AS) or media application provider (AP)) may signal such data in a packet header extension, such as an RTP header extension or a QUIC header extension.

Media applications often transmit data bursts according to specific quality of service (QoS) handling. Existing mechanisms, such as single-bit expedited transfer indications, may not provide sufficient information to distinguish between disparate resource needs like increased bitrate versus reduced latency. A network entity observing local traffic can estimate throughput but cannot accurately deduce end-to-end delay requirements from local observations alone. Consequently, a generic request for boosting provides insufficient information for the network to address specific bottlenecks, potentially leading to inefficient resource allocation that increases bitrate on non-bottleneck links without resolving latency issues.

To address these challenges, this disclosure describes techniques for signaling granular QoS requirements within packet header extensions. A source device may insert desired QoS data, such as a target bitrate, a desired reduction in delay, and a target packet error rate, directly into the headers of packets for a media communication session. These techniques apply to transport protocols including Real-time Transport Protocol (RTP) and QUIC. A receiving device or network entity may extract this data to monitor performance metrics against the specific requirements and may generate feedback data or adjust resource allocation based on the comparison.

By distinguishing between bandwidth-intensive and latency-sensitive traffic, the system enables precise prioritization and boosting strategies. This targeted approach improves end-to-end performance metrics, enhances user experience by mitigating specific degradation factors like video freezes, and improves network spectral efficiency by avoiding unnecessary blanket resource allocation.

To address these technical challenges, this disclosure describes techniques for signaling granular quality of service (QoS) requirements within packet header extensions. A sending device, such as a media application server, inserts desired QoS data directly into the headers of packets belonging to a media communication session. This data may include specific targets for bitrate, a desired reduction in delay (e.g., an absolute or relative value), a maximum packet error rate, and an indication of the applicable traffic direction. These techniques apply to various transport protocols, including Real-time Transport Protocol (RTP) and QUIC, enabling the application layer to expose precise performance needs to the network layer.

By extracting these specific QoS requirements from the packet headers, network devices can improve scheduling and resource allocation to match the actual needs of the application. For example, distinguishing between a bandwidth-hungry video frame and a latency-sensitive control message allows the network to apply the appropriate type of boosting. This targeted approach may improve the end-to-end performance of the media session, enhance the user experience (UX) by mitigating specific degradation factors like freeze duration or buffering, and/or increase network spectral efficiency by avoiding unnecessary blanket allocation of resources.

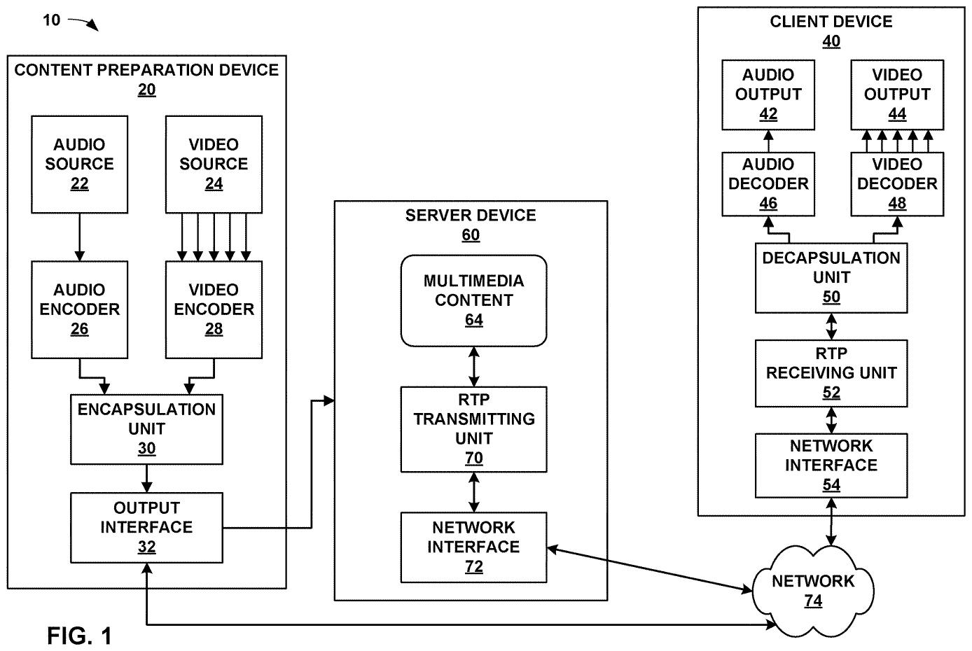

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized into Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and supplemental enhancement information (SEI) NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not be repeated for each sequence or picture; hence, coding efficiency may be improved. Furthermore, the use of parameter sets may enable out-of-band transmission of the header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of scalable video coding (SVC) and view scalability information SEI messages in multiview video coding (MVC). These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement User Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60. In particular, client device 40 (utilizing, for example, RTP receiving unit 52 and network interface 54) may function as a device for receiving data via network 74.

Per techniques of this disclosure, client device 40 may receive a packet from, e.g., server device 60, and extract data representing quality of service (QoS) requirements for the packet of from a packet header extension of the packet. Client device 40 may monitor one or more performance metrics of the media communication session based on the QoS requirements to determine a monitored performance metric. Client device 40 may compare the monitored performance metric to the QoS requirements to generate feedback data. Client device 40 may send the feedback data to a source device (e.g., server device 60) that sent the packet as part of the media communication session. The QoS requirements may include one or more of a target bitrate for the media communication session, a target change in delay for the media communication session, a target packet error rate, or a target change in the packet error rate. In some examples, the packet header extension comprises a real-time transport protocol (RTP) header extension. Client device 40 may negotiate use of the packet header extension prior to receiving the packet, for example, using session description protocol (SDP).

In some examples, two or more client devices (such as two or more user equipment (UE)) devices may engage in a communication session between each other, in which case each UE may both send and receive data as part of the communication session. In such cases, each UE may include components similar to those of any or all of content preparation device 20, server device 60, and/or client device 40.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Although RTP is explained for purposes of example with respect to FIG. 1, other communication protocols may be used instead of RTP. For example, QUIC may be used to exchange media data between server device 60 and client device 40. Therefore, RTP transmitting unit 70 of server device 60 may alternatively be referred to as a “QUIC transmitting unit,” and RTP receiving unit 52 of client device 40 may alternatively be referred to as a “QUIC receiving unit.” These QUIC transmitting/receiving units may use QUIC instead of, or in addition to, RTP when sending/receiving media data.

Using the packet header extension to signal QoS requirements may allow system 10 to address specific performance bottlenecks that a single-bit indication would not necessarily resolve. Server device 60 may signal a specific need for lower latency rather than higher bitrate, which may allow network 74 to avoid wasting effort from spectral efficiency on unnecessary throughput increases. By enabling network entities to distinguish between bitrate and delay requirements, system 10 may improve end-to-end performance metrics and enhance user experience at client device 40, such as reduced freeze duration and improved buffer management.

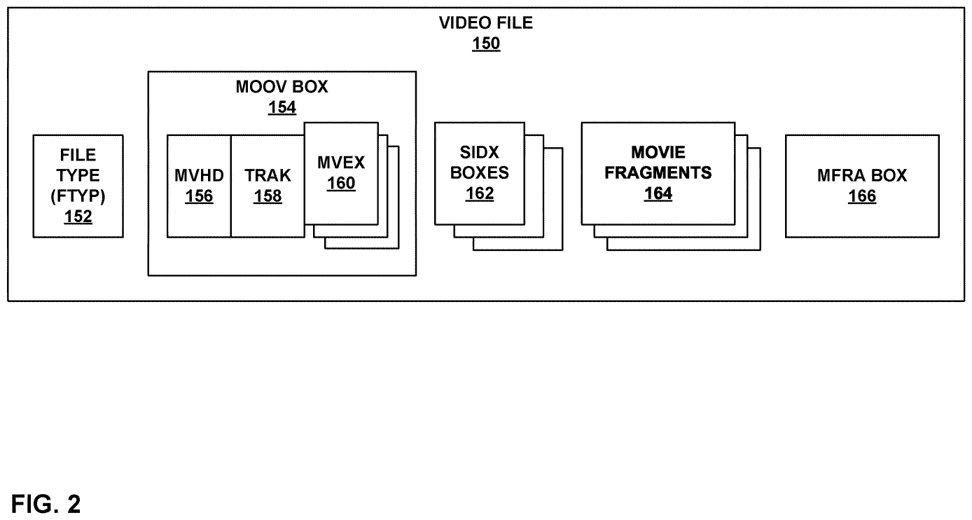

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a particular use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the Third Generation Partnership Project (3GPP) file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

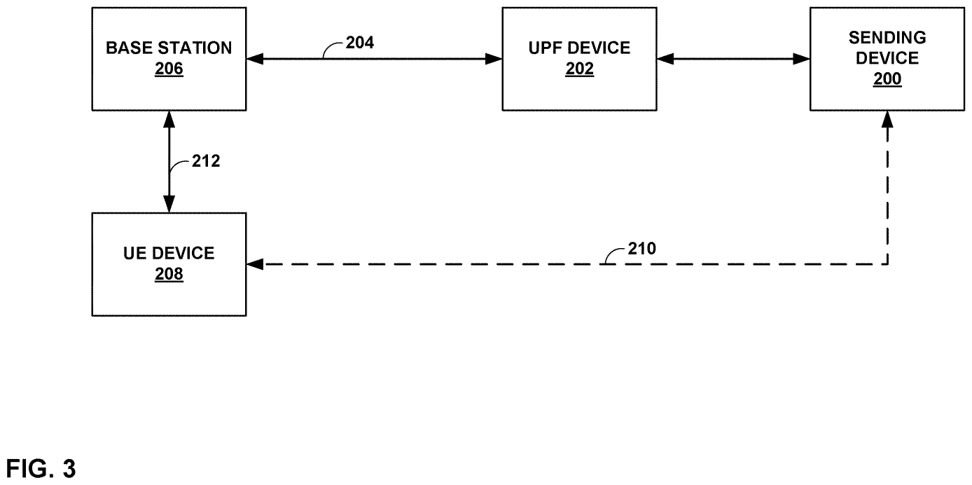

FIG. 3 is a block diagram illustrating an example set of network devices that may perform various aspects of the techniques of this disclosure. The example of FIG. 3 depicts sending device 200, user plane function (UPF) device 202, base station 206, and user equipment (UE) device 208. Sending device 200 may correspond to server device 60 and/or content preparation device 20 of FIG. 1. UE device 208 may correspond to client device 40 of FIG. 1.

Sending device 200 (e.g., an application server (AS) device) may obtain video data to be sent to UE device 208 via communication session 210. To send the video data to UE device 208, sending device 200 may encode the video data (or receive encoded video data from an encoding device, not shown in FIG. 3). Sending device 200 may encapsulate packets including encoded video data (e.g., encoded slices of frames of video data) to form encapsulated packets, e.g., RTP packets or QUIC packets. Sending device 200 may add a packet header extension, such as an RTP header extension or QUIC header extension, to the packets, per techniques of this disclosure. The packet header extension may include, for example, desired bitrate data for a media communication session to which the packet corresponds.

UPF device 202 may receive packets from sending device 200 and form GPRS Tunneling Protocol User Plane (GTP-U) tunneled packets. For example, UPF device 202 may encapsulate the received packets with respective GTP-U headers. Per techniques of this disclosure, UPF device 202 may extract desired bitrate data (e.g., data boosting indication data) from the packets (e.g., from the packet header extension). UPF device 202 may then form the GTP-U headers to include data representing the desired bitrate data. UPF device 202 may send the GTP-U packets to base station 206 via network tunnel 204. Network tunnel 204 may include other network devices, such as network routing devices, configured to forward the GTP-U packets along network tunnel 204 to base station 206. UPF device 202 represents an example of a device for receiving data via a network that extracts data representing quality of service (QoS) requirements for a packet of a media communication session from a packet header extension of the packet.

Base station 206 may receive the GTP-U packets and decapsulate the GTP-U packets to reproduce the original packets. Base station 206 may allocate resources to reception of the GTP-U packets based on, e.g., the desired bitrate data. Base station 206 may then send the packets to UE device 208 via radio access network (RAN) connection 212. UE device 208 may receive the packets from base station 206 via RAN connection 212.

Per techniques of this disclosure, sending device 200 may signal a data boosting indication, which may include desired bitrate information, in a packet header extension, such as an RTP header extension or a QUIC header extension. The data boosting indication may be an expedited transfer indication. Sending device 200 may signal, for example, a desired bitrate, a change to a current bitrate, a desired change in delay, a desired packet error rate (PER) or change to the PER, and/or a traffic direction to which the desired bitrate information applies.

Sending device 200 may express a desired bitrate as an absolute value, e.g., 5 Mbps. Additionally or alternatively, sending device 200 may signal a desired change to the current bitrate, such as “increase” without a specified amount, increase by an absolute amount (e.g., 0.5 Mbps), and/or an increase by a relative amount (e.g., 10%). Desired bitrate may be preferable, because a local bitrate (e.g., in a time slot) at a network entity (e.g., a RAN downlink (DL)) may be very high, and further increasing the local bitrate may not lead to an increase in end-to-end bitrate. For example, when a bottleneck occurs at a remote RAN uplink (UL) for a path including UE2→remote RAN→local RAN→UE1. At the same time, such an increase to a path segment that already has a high bitrate may reduce spectral efficiency.

Sending device 200 may specify a desired change in delay as, e.g., a decrease without a specified amount, a reduction of an absolute amount (e.g., 10 ms), a reduction of a relative amount (e.g., 10%), and/or a desired delay value (e.g., 50 ms). The desired delay value may represent an upper bound to the end-to-end delay. The desired change in delay by an absolute amount may be preferred, because a network entity can act upon it based on locally observable data. The delay may be one-way delay or round-trip time (RTT).

Sending device 200 may specify a desired packet error rate (PER) and/or a desired change to the PER.

Sending device 200 may specify whether the desired bitrate, change in delay, and/or PER is applicable to a particular traffic direction, e.g., sending direction (from sending device 200 to UE device 208), receiving direction (from UE device 208 to sending device 200), or both sending and receiving directions. Changes may be expressed as positive or negative values.

Various devices, such as sending device 200, UPF device 202, and/or base station 206, may compare monitored end-to-end performance metrics (including throughput and delay) with target end-to-end performance metrics. Additionally or alternatively, these devices may monitor actual or inferred degradation and/or improvement to a user experience (UX), e.g., of a user of UE device 208 for communication session 210.

Sending device 200 may signal the data boosting indication in an RTP header extension. To negotiate the use of the data boosting indication and the RTP header extension, sending device 200, UPF device 202, and/or base station 206 may exchange session description protocol (SDP) data. An RTP sender and RTP receiver may negotiate the use of the RTP header extension using SDP Offer and SDP Answer messages. The SDP Offer and SDP Answer messages may include negotiation data conforming to the following augmented Backus-Naur form (ABNF):
extensionname=“urn:3gpp:expedited transfer:rel-19”
extensionattributes=[format] [SP “bitrate-abs”] [SP “delay-delta” SP] [SP “direction”]
format=“short”/“long” (which may indicate whether the RTP header extension takes the short (1-byte) format or the long (2-byte) format)
The presence/absence of “bitrate-abs” may indicate the presence/absence of a field for the desired bitrate with an absolute amount in the RTP header extension.
The presence/absence of “delay-delta” may indicate the presence/absence of a field for the desired change in the delay in the RTP header extension.
The presence/absence of “direction” may indicate the presence/absence of the direction field in the RTP header extension.

As an example, the following data may be signaled in an SDP Offer and/or SDP Answer message:
a=extmap:5 urn:3gpp:expedited transfer:rel-19 short bitrate-abs delay-delta.
   Per the ABNF above, this example data may indicate an RTP header extension in the short format with an RTP header extension ID 5 that includes both a desired absolute bitrate and a desired change in one-way delay. That is, in this example, “short” indicates that the RTP header extension will conform to the “short” format (i.e., one byte format), “bitrate-abs” indicates that the RTP header extension will include a field for an absolute amount of desired bitrate, and “delay-delta” indicates that the RTP header extension will include a field for a desired change in delay. Absence of a “direction” value may indicate that a default direction (e.g., one-way) is to be used.

Equipping sending device 200 with the capability to signal specific QoS requirements, such as bitrate versus delay, in the packet header extension allows various devices of FIG. 3 to participate in improving communications, which may overcome limitations associated with relying solely on local network observations. UPF device 202 may extract this information and forward the data to base station 206 via a GTP-U header. Base station 206 may use the explicit delay and bitrate targets to differentiate between bandwidth-hungry and latency-sensitive traffic. This differentiation may enable base station 206 to allocate radio resources efficiently, facilitating that latency-sensitive packets receive the necessary prioritization to reduce end-to-end delay, a result that a simple bitrate boost might not achieve. Consequently, the architecture depicted in FIG. 3 may facilitate a granular response to changing network conditions, which may improve spectral efficiency of the RAN and the quality of experience for the media session.

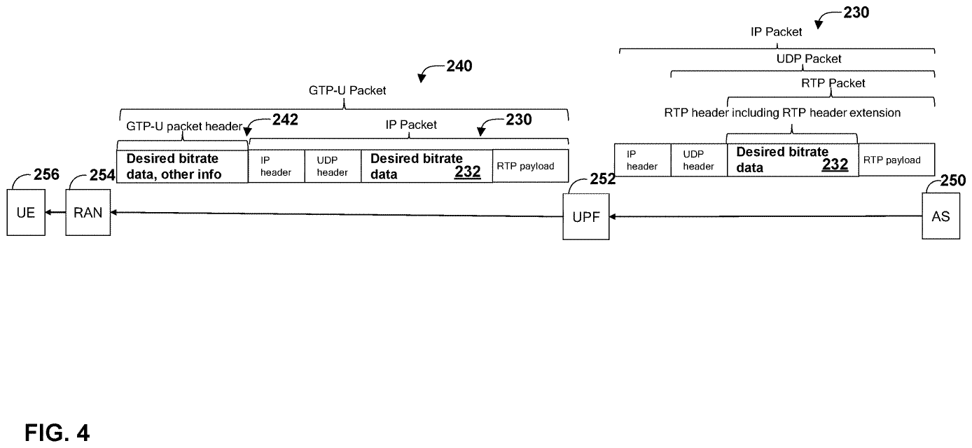

FIG. 4 is a conceptual diagram illustrating an example real-time transport protocol (RTP) packet including an RTP header extension per techniques of this disclosure. In this example, FIG. 4 depicts AS device 250, which may correspond to sending device 200 of FIG. 3; UPF device 252, which may correspond to UPF device 202 of FIG. 3; RAN 254, which may correspond to base station 206 and RAN 212 of FIG. 3; and UE device 256, which may correspond to UE device 208 of FIG. 3.

Additionally, FIG. 4 depicts IP packet structure for packets sent by AS device 250 to UPF device 252. In this example, IP packet 230 encapsulates a UDP packet, which encapsulates an RTP packet including an RTP header and RTP header extension and an RTP payload. The RTP header extension, per techniques of this disclosure, may include desired bitrate data 232, as discussed above. The RTP packet is encapsulated by a UDP header to form the UDP packet. The UDP packet is encapsulated with an IP header to form IP packet 230.

Desired bitrate data 232 may specify one or more quality of service (QoS) requirements. The QoS requirements may include one or more of a target bitrate for the media communication session, a target change in delay for the media communication session, a target packet error rate for the media communication session, or a target change in the packet error rate.

UPF device 252 encapsulates IP packet 230 with GTP-U header 242 to form GTP-U packet 240. GTP-U header 242 includes, among other data, desired bitrate data extracted (and potentially modified) from the RTP header and RTP header extension. The base station of RAN 254 may use the data burst information for scheduling reception of GTP-U packets and to inform UE device 256 as to how to schedule reception of forthcoming packet(s).

UE device 256 and/or the base station of RAN 254 may also monitor at least one performance metric of the media communication session based on the QoS requirements to determine a monitored performance metric. UE device 256 may compare the monitored performance metric to the QoS requirements to generate feedback data. UE device 256 may then send the feedback data to AS device 250 to adjust the media communication session. In some examples, AS device 250 and UE device 256 negotiate use of the packet header extension prior to receiving the packet, for example, using session description protocol (SDP).

Incorporating granular QoS requirements, such as specific targets for bitrate and delay, into the RTP header extension may offer technical advantages over conventional binary boosting indications. Explicit signaling of these parameters may enable system 10 to differentiate between distinct performance needs, such as latency sensitivity versus bandwidth demand. This differentiation may allow for precise resource allocation, which may lead to low-latency traffic receiving appropriate prioritization and high-bandwidth traffic receiving appropriate throughput. In this manner, these techniques may improve spectral efficiency and reduce the likelihood of resource wastage on ineffective adjustments.

Additionally, the comparison of monitored performance metrics against the specific QoS requirements by UE device 256 and/or the base station of RAN 254 may facilitate a responsive adaptation loop. Generating feedback data based on this comparison may allow AS device 250 to dynamically adjust transmission parameters to match the actual conditions experienced by the receiver. This closed-loop mechanism may enhance the resilience of the media communication session, potentially reducing instances of video freeze or buffering by proactively addressing specific performance degradations identified through the packet header information.

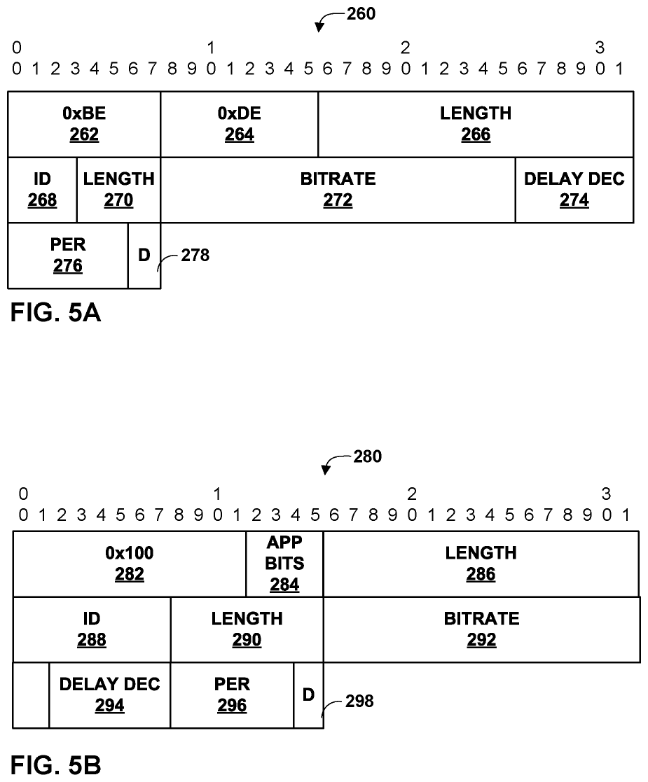

FIGS. 5A and 5B are conceptual diagrams illustrating examples of RTP header extensions per techniques of this disclosure. FIG. 5A depicts an example one-byte RTP header extension format, while FIG. 5B depicts an example two-byte RTP header extension format.

In the example of FIG. 5A, one-byte header extension format 260 includes eight-bit “0×BE” hex value 262, eight-bit “0×DE” hex value 264, 16-bit length value 266, four-bit identifier (ID) value 268, and four-bit length value 270 (e.g., having a value of 2). In the example of FIG. 5B, two-byte header extension format 280 includes 12-bit “0×100” hex value 282, 4-bit appbits value 284, 16-bit length value 286, eight-bit identifier (ID) value 288, and eight-bit length value 290 (e.g., having a value of 3). Both examples include respective 18-bit bitrate value 272, 292; 6-bit delay decrease (delayDec) value 274, 294; 6-bit packet error rate (PER) value 276, 296, and two-bit direction (D) value 278, 298.

Bitrate value 272, in these examples, is an 18-bit field specifying a desired bitrate as an unsigned integer in units of kbps. Bitrate value 272 represents an example of a target bitrate for the media communication session included in the packet header extension.

delayDec value 274, 294, in these examples, is a 6-bit field specifying a desired decrease in delay as an unsigned integer value in units of milliseconds.

PER value 276, 296, in these examples, is a 6-bit field specifying a multiplier (m, denoted by the first 3 bits) and exponents (k, denoted by the second 3 bits) for the desired PER in the form of m×10^{-k} seconds.

D value 278, 298, in these examples, is a 2-bit value specifying a traffic direction, e.g., “01” for send only, “10” for receive only, and “11” for send and receive. A value of “00” for this field indicates a default value, e.g., “receive only.”

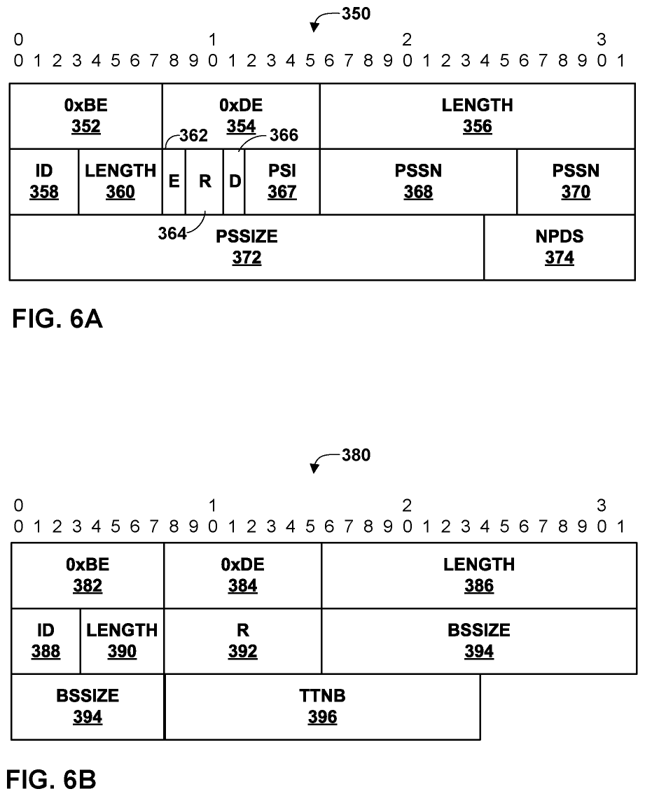

FIGS. 6A and 6B are conceptual diagrams illustrating additional examples of RTP header extensions per techniques of this disclosure. In some examples, rather than using entirely new RTP extension headers, existing RTP extension headers may be used to signal desired bitrate data. For example, a PDU Set Marking RTP extension header (per FIG. 6A) and/or a Dynamically Changing Traffic Characteristics RTP extension header (per FIG. 6B) may be used to signal desired bitrate data, per techniques of this disclosure.

In some examples, a media application function (AF) device may perform a procedure for expedited data transfer. The media AF device may provide a service data flow (SDF) filter and two sets of QoS requirements to the RAN, e.g., the 5G network. Each of the sets of QoS requirements may be mapped to a respective 5QI. The corresponding application may annotate outgoing packets with an RTP header extension that indicates whether expedited transfer indication is true or false, based on monitored QoS metrics (e.g., delay, jitter, and/or throughput) or monitored/inferred user experience (UX). The UPF device (e.g., UPF device 202 of FIG. 3) may extract the expedited data transfer indication and apply the corresponding 5QI.

The expedited data transfer indication may be a single bit. In some examples, a dedicated RTP header extension for the expedited data transfer indication may incur too much overhead. Thus, per techniques of this disclosure, in some examples, an existing RTP header extension may be used to signal the expedited data transfer indication, and in some examples, an existing QUIC header extension may be used to signal the expedited data transfer indication.

One or more reserved bits in existing RTP header extensions (e.g., the RTP header extension for PDU Set Marking (defined in 3GPP TS26.522) or the RTP header extension for Dynamically Changing Traffic Characteristics (defined in 3GPP TS26.522)) may be used to indicate whether an expedited transfer indication is true (e.g., when the bit is set to 1) or false (e.g., when the bit is set to 0). Additionally, other reserved bits in existing RTP header extensions may indicate the direction to which the indication applies, e.g., two bits may have values of “01” for sending direction only, “10” for receiving direction only, or “11” for sending and receiving directions. A value of “00” may represent a default value, e.g., receiving direction only. One or more reserved bits in existing QUIC header extensions may be used to indicate whether an expedited transfer indication is true (e.g., when the bit is set to 1) or false (e.g., when the bit is set to 0).

The example of FIG. 6A depicts RTP header extension for PDU Set Marking 350 as defined in 3GPP TS26.522. The example of FIG. 6A depicts a one-byte format for RTP header extension for PDU Set Marking 350. RTP header extension for PDU Set Marking 350 includes 0×BE field 352, 0×DE field 354, length field 356, identifier (ID) field 358, length field 360, expedited transfer indication (E) field 362, reserved (R) field 364, direction (D) field 366, PSI field 367, PSSN field 368, PSSN field 370, PSSize field 372, and NPDS field 374. The use of R field 364 and D field 366 may also apply to the two-byte format for this RTP header extension.

In this example, two reserved bits of R field 364 may be used as follows. A first bit, which may be for an indication of whether expedited transfer indication is true (e.g., when the bit is set to 1) or false (when the bit is set to 0). In some examples, a second bit may be used to indicate direction to which the expedited transfer indication applies, e.g., “0” may indicate receiving direction only and “1” may indicate both sending and receiving directions. In some examples, these two bits of R field 364 together may form a two-bit value that indicates the direction as follows: “01” for sending direction only, “10” for receiving direction only, “11” for both sending direction and receiving direction, and “00” for a default value (e.g., receiving direction only).

The example of FIG. 6B depicts RTP header extension for Dynamically Changing Traffic Characteristics 380, e.g., similar to that defined in 3GPP TS26.522. The example of FIG. 6B depicts a one-byte format including 0×BE field 382, 0×DE field 384, length field 386, ID field 388, length field 390, reserved (R) field 392, burst size (BSSize) field 394, and time to next burst (TTNB) field 396. A two-byte format for RTP header extension for Dynamically Changing Traffic Characteristics 380 includes a similar R field, and thus, the techniques of this disclosure as discussed with respect to the example of FIG. 6B may also be applied to the two-byte format of RTP header extension for Dynamically Changing Traffic Characteristics 380.

In this example, R field 392 includes 8 bits. Per techniques of this disclosure, a first bit of R field 392 may be set to either 1 to indicate that an expedited transfer indication is true or 0 to indicate that the expedited transfer indication is false. Second and third bits of R field 392 may be used to indicate a traffic direction to which the expedited transfer indication applies. For example, “01” may indicate that the expedited transfer indication applies to the sending direction, “10” to the receiving direction, “11” to both the sending and receiving directions, and “00” to a default (e.g., receiving direction only).

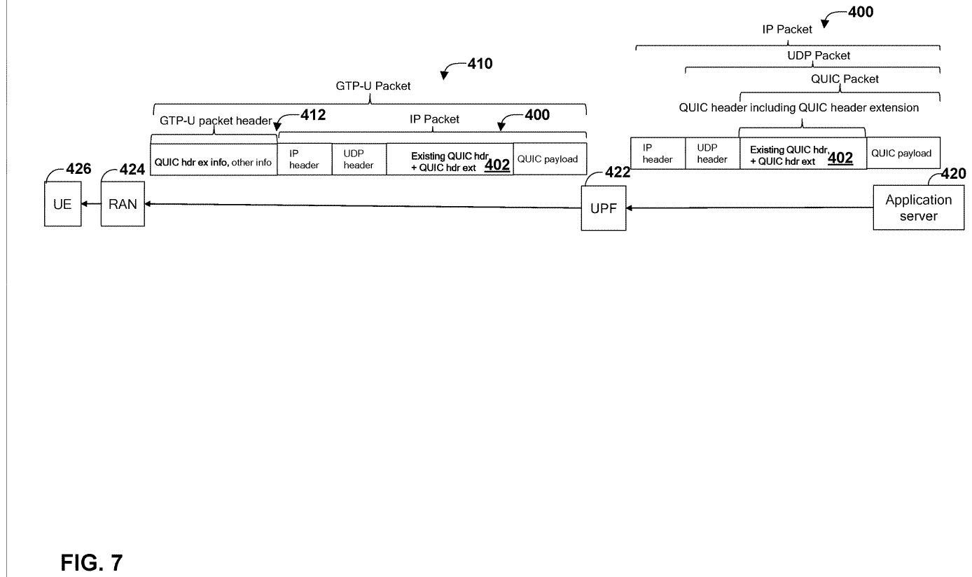

FIG. 7 is a conceptual diagram illustrating an example of use of QUIC packets including QUIC header extensions including data boosting indication information per techniques of this disclosure. In this example, FIG. 7 depicts IP packet 400, GTP-U packet 410, QUIC header extension 402, GTP-U packet header 412, application server 420, UPF device 422, RAN 424, and UE 426. In some examples, a protocol description may include data indicating the protocol (QUIC), the type of the QUIC header extension being for data boosting indication, and a QUIC header extension identifier, e.g., 3. An AF device (e.g., application server 420) may extract the protocol description and send data representing the protocol description to a policy control function (PCF)device. The PCF device may generate policy and charging control (PCC) rules and configure a session management function (SMF) device accordingly. The SMF device may configure UPF device 422 on how to identify QUIC packets with PDU Set marking. Application server 420 represents an example of a source device that sends the packet as part of the media communication session. QUIC header extension 402 represents an example of a packet header extension including data representing quality of service (QoS) requirements (e.g., the data boosting indication).

UPF device 422 may identify (based on the protocol description) the QUIC packets with the QUIC header extensions including data boosting indication data. UPF device 422 may then extract the PDU Set marking information, including desired bitrate data such as QoS requirements, from QUIC header extension 402. UPF device 422 may further encapsulate each QUIC packet with GTP-U packet header 412 into GTP-U packet 410 and add the extracted data boosting indication in GTP-U packet header 412. The base station of RAN 424 may use the QoS requirements extracted from the GTP-U packet header for scheduling or otherwise adapt behavior of UE device 426.

Negotiation for the use of a QUIC header extension that signals data boosting indication data may be performed as follows. In some examples, the negotiation may be performed in-band, e.g., using negotiation frames in session setup. Negotiation data may be carried in certain QUIC packets (e.g., initial packet, handshake packet, and/or 1-RTT packet) during the handshake phase. In some examples, two frames are defined and sent as part of the normal payload of initial packets: a “QUIC header extension request” frame that carries the header extension IDs and the respective definition of the extension, e.g., “urn:3gpp:expedited transfer:rel-19,” and a “QUIC header extension response” frame that confirms support for the type of header extension through indicating the header extension ID in the reply and that may be included in the initial packet from the server to the client. Specifically, the “QUIC header extension request” frame may include a payload mapping a proposed header extension identifier (ID) to a specific definition string (e.g., “urn:3gpp:expedited transfer:rel-19”). The “QUIC header extension response” frame may include a payload indicating the header extension ID that is accepted and supported by the responding device. An intermediate router (e.g., UPF device 202) may inspect these frames to decode the mapping between extension IDs and their definitions to interpret subsequent encrypted packets. Although initial packets are encrypted, the encryption uses a key derived from cleartext connection identifier (ID) data and a well-known number (referred to as a “salt” value), and intermediate routers or other network devices can inspect the packet and decode the payload (carrying the request/response frame) and determine the meaning of the header extensions.

In some examples, the two frames defined above are not encrypted in the QUIC packets (e.g., initial packet, handshake packet, and/or 1-RTT packet).

In some examples, transport parameters may be defined and exchanged in QUIC messages during the handshake phase to indicate support for a particular QUIC header extension. The transport parameters may represent declarations made unilaterally by each endpoint as to support for, e.g., various QUIC header extensions. For example, one endpoint (e.g., the UE device) may send the transport parameter to indicate support for a QUIC header extension, and the other endpoint (e.g., the server device) may send a reply via a transport parameter to indicate that it accepts the header extension. The transport parameter may contain a header extension identifier (ID) and the definition of the header extension, e.g., “urn:3gpp:expedited transfer:rel-19.”

In some examples, negotiation for the QUIC header extension may be performed out-of-band, e.g., using metadata in an assistance protocol (e.g., SDP when RTP over QUIC is used) and exchanged between the endpoints.

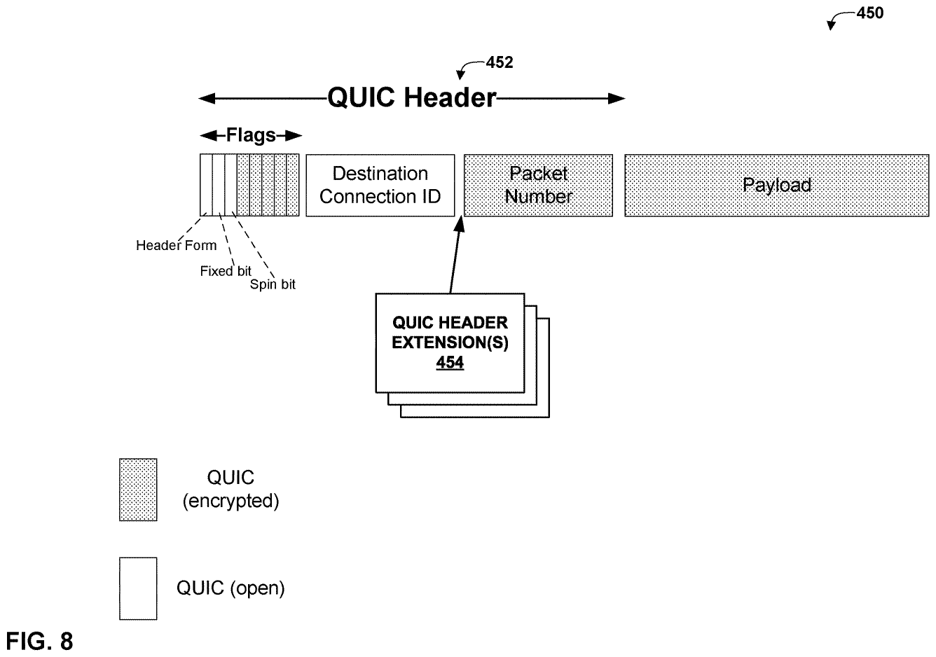

FIG. 8 is a conceptual diagram illustrating example QUIC packet 450. This packet may be referred to as a “1-RTT QUIC packet.” As shown in FIG. 8, QUIC packet 450 includes unencrypted data (labeled “QUIC (open)” and encrypted data (labeled “QUIC (encrypted)”). As shown in FIG. 8, QUIC header 452 for QUIC packet 450 includes both encrypted and unencrypted data. In QUIC header 452, only part of the flags and the Destination Connection ID are unencrypted, as shown in FIG. 8. The flags include only 3 unencrypted bits in a 1-RTT packet format: Header Form (1)=0; Fixed Bit (1)=1; and Spin Bit (1). The spin bit need not be encrypted, because it has been determined that the spin bit does not leak any information to the network.

As illustrated in FIG. 8, QUIC packet 450 includes QUIC header extension(s) 454. QUIC header extension(s) 454 may function as the packet header extension including data representing quality of service (QoS) requirements for the media communication session. Sending device 200 may include the QoS requirements in QUIC header extension(s) 454. The QoS requirements may comprise one or more of a target bitrate, a target change in delay, a target packet error rate, or a target change in the packet error rate. A device for receiving data may extract the data representing the QoS requirements from QUIC header extension(s) 454. The device monitors at least one performance metric of the media communication session based on the QoS requirements to determine a monitored performance metric. The device compares the monitored performance metric to the QoS requirements to generate feedback data. The device sends the feedback data to a source device (e.g., sending device 200) that sent QUIC packet 450 as part of the media communication session.

Per the techniques of this disclosure, one or more QUIC header extensions 454 may be added to the QUIC packet of FIG. 8, as shown in the example of FIG. 8. Such QUIC header extensions may include unencrypted application layer information that may improve cross-layer efficiency if exposed to the network, e.g., data boosting indication information. The QUIC header itself may include data indicating the presence of the QUIC header extensions. For example, the QUIC header may include a QUIC version number, where the QUIC version number indicates whether and/or how many QUIC header extensions are present. Additionally or alternatively, the QUIC header may include a dedicated indicator that indicates whether one or more QUIC header extensions are included. For example, the dedicated indicator may be one of two reserved bits in the 1-RTT packet header.

A QUIC packet may carry one or more header extensions (e.g., extension elements). Each header extension may include a header and header extension data. The header may include an extension identifier that identifies the type of the header extension in a QUIC connection and an extension length indicating the length of the header extension, e.g., in bytes or other relevant size units (bits, words, etc.) The header extension data may include data or metadata to be communicated to the network transporting the QUIC packet. Multiple extension formats may be used, e.g., a one-byte format including the extension ID and extension length together in one-byte, or a two-byte format including the extension ID and extension length together in two-bytes.

In some examples, all QUIC header extensions are unencrypted. An application or device receiving the QUIC header extension may determine whether to use unencrypted QUIC header extension information, based on its implementation. In some examples, the QUIC packet header indicates which of the QUIC header extensions are encrypted or not encrypted, e.g., using a bitmap. For example, the bitmap may be an array of bits each corresponding to one of the QUIC header extensions, where a value of 1 for the bit indicates that the QUIC header extension is encrypted and a value of 0 for the bit indicates that the QUIC header extension is unencrypted. In some examples, the QUIC header extension(s) may be ignored by an endpoint that does not support the QUIC header extension(s), and does not change the meaning of the conventional QUIC header fields.

In some examples, a QUIC packet with one or more header extensions may have a format similar to the following format:
1-RTT Packet {
   Header Form (1)=0,
   Fixed Bit (1)=1,
   Spin Bit (1),
   Reserved Bits (2)=10,
   Key Phase (1),
   Packet Number Length (2),
   Destination Connection ID (0 . . . 160),
   Packet Number (8 . . . 32),
   Extension ID (4)=1,
   Extension Length (4)=12,
   Extension data (96),
   Extension ID (4)=2,
   Extension Length (4)=4,
   Extension data (32),
   Packet Payload (8 . . . ),
}

In this example, the format represents a QUIC packet having two QUIC header extensions, indicated by respective extension ID, extension length, and extension data fields. The first QUIC header extension includes an extension ID value of 1 (represented by four bits), an extension length value of 12 (indicating that the extension data field has 12 bytes, i.e., 96 bits) and an extension data field of 96 bits of data. The second QUIC header extension includes an extension ID value of 2, an extension length value of 4 (indicating that the extension data field has 4 bytes, i.e., 32 bits), and an extension data field of 32 bits of data. In the format above, a field is represented by the field name, followed by a value in parentheses (indicating a number of bits for that field), and an optional assigned value for the field indicated by an equals sign followed by the value.

Negotiation of the use of QUIC header extensions may be performed between two endpoint devices, such as between a UE device (e.g., UE device 208 of FIG. 3) and an AS device (e.g., sending device 200 of FIG. 3). In some examples, this negotiation may be performed in-band, where negotiation frames are exchanged during session setup. Negotiation data may be carried in some QUIC packets (e.g., initial packet, handshake packet(s), and/or 1-RTT packet(s)) during the handshake phase. In some examples, two frames are defined and sent as part of the normal payload of the initial packets. The two frames may include a “QUIC header extension request” frame, which carries the header extension IDs and respective definitions of the extensions. The QUIC header extension request frame may be included in the initial packet from the client to the server, where the definition may be indicated by a URL, uniform resource identifier (URI), or URN (which may be registered with the Internet Assigned Numbers Authority (IANA)). The two frames may also include a “QUIC header extension response” frame, which confirms support for the types of header extensions through indication of the respective header extension IDs, and may be included in the initial packet from the server to the client. Although the two initial packets are encrypted, this encryption generally uses a key derived from a cleartext connection ID and a well-known salt number, such that intermediate routers (e.g., UPF device 202) can inspect the packet(s) and decode the payload (carrying the request/response frames) to determine the meaning of the header extensions.

Alternatively, the two frames may be as indicated above, but the frames need not be encrypted in the QUIC packets (e.g., initial packet, handshake packet, and 1-RTT packet). This may simplify the complexity at intermediate routers (e.g., UPF device 202 of FIG. 3), but may change encryption procedures at QUIC endpoints (e.g., UE device 208 and sending device 200).

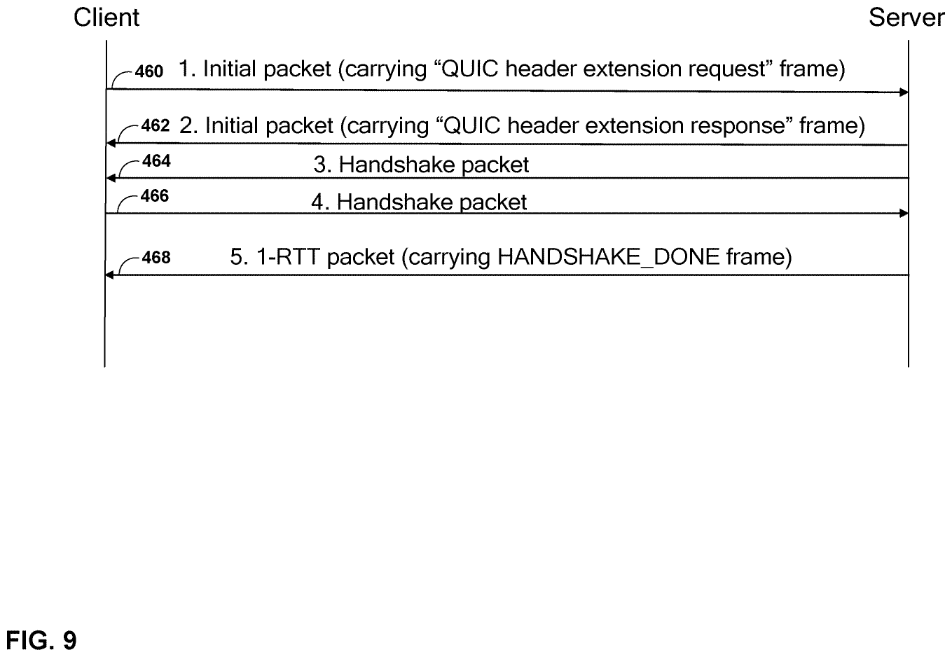

FIG. 9 is a call flow diagram illustrating an example method for negotiating use of QUIC header extensions per techniques of this disclosure. In this example, initially, a client device (e.g., UE device 208 of FIG. 3 or client device 40 of FIG. 1) sends an initial QUIC packet carrying a “QUIC header extension request” frame as discussed above to a server device (e.g., sending device 200 of FIG. 3 or server device 60 of FIG. 1) (460). In particular, the QUIC header extension request frame may request support for data boosting indication information per techniques of this disclosure. The request may indicate a header extension ID value and definition of the header type, such as a URN “urn:3gpp:expedited transfer:rel-19”, URI, URL, or an index value.

The server device then responds with an initial packet carrying a “QUIC header extension response” frame (462) as discussed above. In particular, the server device may respond with a QUIC header extension response indicating support for data boosting indication information per techniques of this disclosure. For example, the response may contain the extension ID supported by the QUIC server if the server supports data boosting indication information per these techniques. The server and client devices then exchange handshake packets (464, 466). The server device then sends a 1-RTT packet carrying a “HANDSHAKE_DONE” frame (468). This may result in QUIC session establishment, and the server device can proceed to send QUIC packets including QUIC header extensions according to the session negotiation, per the techniques of this disclosure.

The request and response may be sent in two dedicated QUIC frames, e.g., as discussed above.

When the initial packets (client to server, and server to client) are used, the request and response may, or may not, be encrypted. In general, even if the Initial packets are encrypted, a network entity may still be capable of decrypting the Initial packets, due to the encryption scheme. When other packets (Handshake packets, 1-RTT packet) are used, the request and response need not be encrypted.

In the example of FIG. 9, the client device acts as a device for receiving data via a network, and the server device acts as a source device sending the packet as part of the media communication session. Both the client and the server may act as source and/or destination of media data included in packets encapsulated with packet headers including QoS requirements, per techniques of this disclosure. The illustrated process represents negotiating use of the packet header extension prior to receiving the packet including the packet header extension. Specifically, the request and response frames constitute negotiation frames exchanged in session setup. In other examples, the devices may negotiate use of the QUIC header extension by exchanging transport parameters indicating unilateral declarations of support for QUIC header extensions during a handshake phase of QUIC (e.g., within the handshake packets). Following this negotiation, the processing system of the client device extracts data representing quality of service (QoS) requirements (e.g., target bitrate, target change in delay) from the packet header extension of a received packet, monitors performance metrics, and generates feedback data based on a comparison of the metrics to the QoS requirements.

In some examples, QUIC header extension negotiation may be performed out of band, e.g., using SDP signaling. SDP Offer and Answer messages may allow the endpoints to negotiate the use of the QUIC header extensions, e.g., for RTP over QUIC. A first endpoint may send an SDP Offer message containing data indicating supported QUIC header extensions. A second endpoint may then reply with an SDP Answer message containing data indicating its own supported QUIC header extensions, e.g., as a subset of the supported QUIC header extensions of the first endpoint. The two endpoints may then use any of the QUIC header extensions indicated in the SDP Answer message.

The SDP Offer and Answer messages may carry an SDP attribute “quicextmap” including an extension name (e.g., URI, URN, or URL) and extension attributes (e.g., optional configurations). The ABNF syntax may be as follows:
Name: quicextmap
Value: quicextmap-value
Syntax:
   quicextmap-value=mapentry SP extensionname [SP extensionattributes]
   mapentry=“quicextmap:” 1*5DIGIT [“/” direction]
   extensionname=URI
   extensionattributes=byte-string
   direction=“sendonly”/“recvonly”/“sendrecv”/“inactive”
   URI=<Defined in RFC 3986>
   byte-string=<a byte string, defined in RFC 4566>
   SP=<the “space” ASCII character>
   DIGIT=<numbers 0 through 9>

The extension name may be, “urn:3gpp:expedited transfer:rel-19.” The extension may include an indication of whether optional fields are present, e.g., whether the NPDS element is present and/or whether the PSSize element is present. The extension attributes may be formatted according to “[format] [SP “bitrate-abs”] [SP “delay-delta” SP] [SP “direction”],” as discussed above.

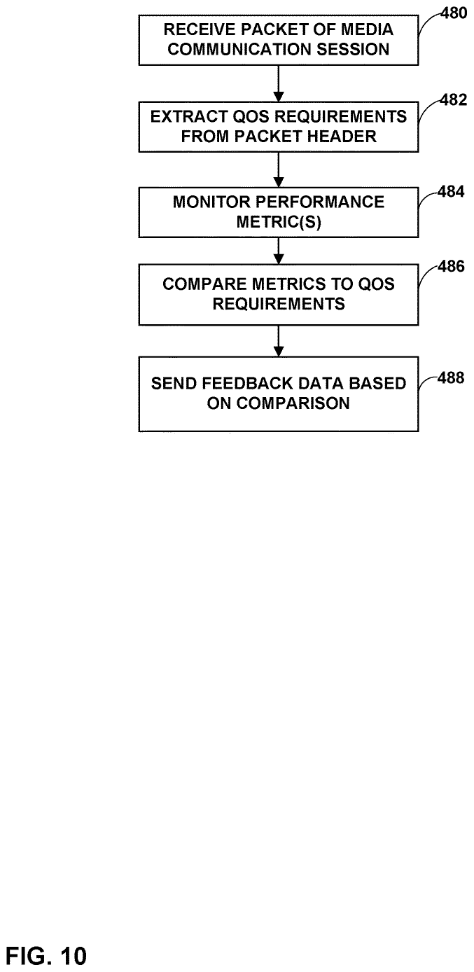

FIG. 10 is a flowchart illustrating an example method of improving quality of service (QoS) of a media communication session per techniques of this disclosure. A device for receiving data, such as UE device 208 or client device 40, may perform the method of FIG. 10. In some examples, the device negotiates use of a packet header extension prior to receiving a packet including the packet header extension. For an RTP session, the device may negotiate use of an RTP header extension using Session Description Protocol (SDP). For a QUIC session, the device may negotiate use of a QUIC header extension in-band using negotiation frames in session setup or by exchanging transport parameters indicating unilateral declarations of support during a handshake phase.

The device receives the packet of the media communication session (480), where the packet includes a packet header extension including quality of service (QoS) requirements for the packet. The device extracts data representing the QoS requirements for the packet from the packet header extension of the packet (482). The packet header extension may include fields for one or more of a target bitrate, a target decrease in delay, a multiplier value for a target packet error rate, or a traffic direction. The QoS requirements may include a target change in delay or a target change in packet error rate specified in no amount, a relative amount, or an absolute amount.

The device then monitors at least one performance metric of the media communication session based on the QoS requirements to determine a monitored performance metric (484). Monitoring such performance metrics may include measuring throughput, latency, or user experience metrics, such as video freeze duration. The device then compares the monitored performance metric to the QoS requirements to generate feedback data (486). The device then sends the feedback data to a source device (e.g., sending device 200) that sent the packet (488). This feedback data enables the source device or intermediate network entities to adjust transmission parameters, such as allocating resources to reduce delay or increase bitrate, which may thereby improve the media communication session.

In this manner, the method of FIG. 10 represents an example of a method of receiving data via a network, including: extracting data representing quality of service (QoS) requirements for a packet of a media communication session from a packet header extension of the packet; monitoring at least one performance metric of the media communication session based on the QoS requirements to determine a monitored performance metric; comparing the monitored performance metric to the QoS requirements to generate feedback data; and sending the feedback data to a source device that sent the packet as part of the media communication session.

Various examples of the techniques of this disclosure are summarized in the following clauses:

Clause 1: A method of exchanging data via a network, the method comprising exchanging a packet of a media communication session, the packet including a packet header extension, the packet header extension including desired bitrate data for the media communication session.

Clause 2: The method of clause 1, wherein the desired bitrate data includes one or more of a desired bitrate for the media communication session, a desired change in delay for the media communication session, a desired packet error rate for the media communication session, or a desired change in the packet error rate.

Clause 3: The method of clause 2, wherein the desired bitrate data includes at least one of the desired change in the delay for the media communication session or the desired change in the packet error rate, and wherein the desired bitrate data further includes data representative of a traffic direction to which the desired change applies.

Clause 4: The method of clause 3, wherein the traffic direction comprises one of a send direction, a receive direction, or both the send and receive directions.

Clause 5: The method of any of clauses 2-4, wherein the desired bitrate data includes at least one of the desired change in delay or the desired change in the packet error rate, and wherein the desired change is specified in at least one of no amount, a relative amount, or an absolute amount.

Clause 6: The method of any of clauses 1-5, wherein exchanging comprises receiving, by a network device, the method further comprising: monitoring actual end-to-end performance metrics for the media communication session; and comparing the actual end-to-end performance metrics with target end-to-end performance metrics based on the desired bitrate data.

Clause 7: The method of any of clauses 1-6, wherein exchanging comprises receiving, by a network device, the method further comprising determining changes to a user experience of the media communication session based on the desired bitrate data.

Clause 8: The method of any of clauses 1-5, wherein exchanging comprises sending, by a media application provider (AP) device or by a media application server (AS) device.

Clause 9: The method of any of clauses 1-8, further comprising negotiating use of the packet header extension prior to exchanging the packet including the packet header extension.

Clause 10: The method of clause 9, wherein the packet header extension comprises a real-time transport protocol (RTP) header extension.

Clause 11: The method of clause 10, wherein negotiating the use of the RTP header extension comprises negotiating the use of the RTP header extension using session description protocol (SDP).

Clause 12: The method of clause 11, wherein negotiating the use of the RTP header extension comprises sending or receiving an SDP message, the SDP message comprising one of an SDP Offer message or an SDP Answer message, the SDP message including RTP negotiation data formatted according to: extensionname=“urn:3gpp:expedited transfer:rel-19”; extensionattributes=[format][SP “bitrate-abs”] [SP “delay-delta” SP][SP “direction”]; format=“short”/“long”, wherein “format” indicates whether the RTP header extension has a short format or a long format, wherein presence or absence of bitrate-abs indicates presence or absence of a field for a desired bitrate with an absolute amount in the RTP header extension, wherein presence or absence of delay-delta indicates presence or absence of a field for a desired change in delay in the RTP header extension, and wherein presence or absence of direction indicates presence or absence of a field for a traffic direction in the RTP header extension.

Clause 13: The method of any of clauses 1-12, wherein the packet header extension comprises a real-time transport protocol (RTP) header extension including fields for one or more of a desired bitrate, a desired decrease in delay, a multiplier value for a desired packet error rate, or a traffic direction.

Clause 14: The method of clause 13, wherein the field for the desired bitrate is 18 bits, the field for the desired decrease in delay is 6 bits, the field for the multiplier value is 6 bits, and the field for the direction is 2 bits.

Clause 15: The method of any of clauses 13 and 14, wherein the RTP header extension conforms to a one-byte format including a hex 0×BE value, a hex 0×DE value, a length field having 16 bits, an identifier (ID) field having 4 bits, and an L=2 field having 4 bits.

Clause 16: The method of any of clauses 13 and 14, wherein the RTP header extension conforms to a two-byte format including a hex 0×100 field having 12 bits, an appbits field having 4 bits, a length field having 16 bits, an identifier (ID) field having 8 bits, and an L=3 field having 8 bits.

Clause 17: The method of any of clauses 1-12, wherein the packet header extension comprises one of a real-time transport protocol (RTP) header extension for protocol data unit (PDU) set marking or an RTP header extension for dynamically changing traffic characteristics.

Clause 18: The method of clause 17, wherein the packet header extension comprises the RTP header extension for PDU set marking, and wherein the RTP header extension for PDU set marking includes a first bit having a value indicating whether an expedited transfer indication is true, and a second bit having a value indicating a traffic direction for the expedited transfer indication.

Clause 19: The method of clause 18, wherein a value of true for the second bit indicates both a send direction and a receive direction, and a value of false for the second bit indicates a receive direction only.

Clause 20: The method of clause 17, wherein the packet header extension comprises the RTP header extension for PDU set marking, and wherein the RTP header extension for PDU set marking includes two bits having a value indicating a traffic direction for an expedited transfer indication, wherein a value of “01” indicates send direction only, a value of “10” indicates a receive direction only, a value of “11” indicates both send and receive directions, and a value of “00” indicates a receive direction only.

Clause 21: The method of clause 17, wherein the packet header extension comprises the RTP header extension for dynamically changing traffic characteristics, and wherein the RTP header extension for dynamically changing traffic characteristics includes a first bit having a value indicating whether an expedited transfer indication is true, and a second bit having a value indicating a traffic direction for the expedited transfer indication.

Clause 22: The method of clause 21, wherein a value of true for the second bit indicates both a send direction and a receive direction, and a value of false for the second bit indicates a receive direction only.

Clause 23: The method of clause 17, wherein the packet header extension comprises the RTP header extension for dynamically changing traffic characteristics, and wherein the RTP header extension for dynamically changing traffic characteristics includes two bits having a value indicating a traffic direction for an expedited transfer indication, wherein a value of “01” indicates send direction only, a value of “10” indicates a receive direction only, a value of “11” indicates both send and receive directions, and a value of “00” indicates a receive direction only.

Clause 24: The method of clause 9, wherein the packet header extension comprises a QUIC header extension, and wherein negotiating the use of the QUIC header extension comprises negotiating the use of the QUIC header extension in-band using negotiation frames in session setup.

Clause 25: The method of clause 24, wherein the negotiation frames comprise one or more of an initial packet, a handshake packet, or a 1-RTT packet.

Clause 26: The method of any of clauses 24 and 25, wherein the negotiation frames include: a QUIC header extension request frame including a header extension identifier for the QUIC header extension and a definition of an extension corresponding to the QUIC header extension; and a QUIC header extension response frame including data confirming support for the QUIC header extension.

Clause 27: The method of any of clauses 24-26, wherein the negotiation frames are encrypted.

Clause 28: The method of any of clauses 24-26, wherein the negotiation frames are not encrypted.

Clause 29: The method of clause 9, wherein the packet header extension comprises a QUIC header extension, and wherein negotiating the use of the QUIC header extension comprises exchanging transport parameters indicating unilateral declarations of support for QUIC header extensions during a handshake phase of QUIC.

Clause 30: The method of clause 9, wherein the packet header extension comprises a QUIC header extension, and wherein negotiating the use of the QUIC header extension comprises negotiating the use of the QUIC header extension out-of-band through exchanging metadata in an assistance protocol.

Clause 31: The method of clause 30, wherein the assistance protocol comprises session description protocol (SDP).

Clause 32: A device for receiving data via a network, the device comprising one or more means for performing the method of any of clauses 1-31.

Clause 33: The device of clause 32, wherein the one or more means comprise a memory and a processing system implemented in circuitry.

Clause 34: The device of clause 32, wherein the device comprises at least one of: an integrated circuit; a microprocessor; or a wireless communication device.

Clause 35: A device for exchanging data via a network, the device comprising means for exchanging a packet of a media communication session, the packet including a packet header extension, the packet header extension including desired bitrate data for the media communication session.

Clause 36: A method of exchanging data via a network, the method comprising exchanging a packet of a media communication session, the packet including a packet header extension, the packet header extension including desired bitrate data for the media communication session.

Clause 37: The method of clause 36, wherein the desired bitrate data includes one or more of a desired bitrate for the media communication session, a desired change in delay for the media communication session, a desired packet error rate for the media communication session, or a desired change in the packet error rate.

Clause 38: The method of clause 37, wherein the desired bitrate data includes at least one of the desired change in the delay for the media communication session or the desired change in the packet error rate, and wherein the desired bitrate data further includes data representative of a traffic direction to which the desired change applies.

Clause 39: The method of clause 38, wherein the traffic direction comprises one of a send direction, a receive direction, or both the send and receive directions.

Clause 40: The method of clause 37, wherein the desired bitrate data includes at least one of the desired change in delay or the desired change in the packet error rate, and wherein the desired change is specified in at least one of no amount, a relative amount, or an absolute amount.

Clause 41: The method of clause 36, wherein exchanging comprises receiving, by a network device, the method further comprising: monitoring actual end-to-end performance metrics for the media communication session; and comparing the actual end-to-end performance metrics with target end-to-end performance metrics based on the desired bitrate data.

Clause 42: The method of clause 36, wherein exchanging comprises receiving, by a network device, the method further comprising determining changes to a user experience of the media communication session based on the desired bitrate data.

Clause 43: The method of clause 36, wherein exchanging comprises sending, by a media application provider (AP) device or by a media application server (AS) device.

Clause 44: The method of clause 36, further comprising negotiating use of the packet header extension prior to exchanging the packet including the packet header extension.

Clause 45: The method of clause 44, wherein the packet header extension comprises a real-time transport protocol (RTP) header extension.

Clause 46: The method of clause 45, wherein negotiating the use of the RTP header extension comprises negotiating the use of the RTP header extension using session description protocol (SDP).

Clause 47: The method of clause 46, wherein negotiating the use of the RTP header extension comprises sending or receiving an SDP message, the SDP message comprising one of an SDP Offer message or an SDP Answer message, the SDP message including RTP negotiation data formatted according to: extensionname=“urn:3gpp:expedited transfer:rel-19”; extensionattributes=[format][SP “bitrate-abs”] [SP “delay-delta” SP][SP “direction”]; format=“short”/“long”, wherein “format” indicates whether the RTP header extension has a short format or a long format, wherein presence or absence of bitrate-abs indicates presence or absence of a field for a desired bitrate with an absolute amount in the RTP header extension, wherein presence or absence of delay-delta indicates presence or absence of a field for a desired change in delay in the RTP header extension, and wherein presence or absence of direction indicates presence or absence of a field for a traffic direction in the RTP header extension.

Clause 48: The method of clause 36, wherein the packet header extension comprises a real-time transport protocol (RTP) header extension including fields for one or more of a desired bitrate, a desired decrease in delay, a multiplier value for a desired packet error rate, or a traffic direction.

Clause 49: The method of clause 48, wherein the field for the desired bitrate is 18 bits, the field for the desired decrease in delay is 6 bits, the field for the multiplier value is 6 bits, and the field for the direction is 2 bits.

Clause 50: The method of clause 48, wherein the RTP header extension conforms to a one-byte format including a hex 0×BE value, a hex 0×DE value, a length field having 16 bits, an identifier (ID) field having 4 bits, and an L=2 field having 4 bits.

Clause 51: The method of clause 48, wherein the RTP header extension conforms to a two-byte format including a hex 0×100 field having 12 bits, an appbits field having 4 bits, a length field having 16 bits, an identifier (ID) field having 8 bits, and an L=3 field having 8 bits.

Clause 52: The method of clause 36, wherein the packet header extension comprises one of a real-time transport protocol (RTP) header extension for protocol data unit (PDU) set marking or an RTP header extension for dynamically changing traffic characteristics.

Clause 53: The method of clause 52, wherein the packet header extension comprises the RTP header extension for PDU set marking, and wherein the RTP header extension for PDU set marking includes a first bit having a value indicating whether an expedited transfer indication is true, and a second bit having a value indicating a traffic direction for the expedited transfer indication.

Clause 54: The method of clause 53, wherein a value of true for the second bit indicates both a send direction and a receive direction, and a value of false for the second bit indicates a receive direction only.

Clause 55: The method of clause 52, wherein the packet header extension comprises the RTP header extension for PDU set marking, and wherein the RTP header extension for PDU set marking includes two bits having a value indicating a traffic direction for an expedited transfer indication, wherein a value of “01” indicates send direction only, a value of “10” indicates a receive direction only, a value of “11” indicates both send and receive directions, and a value of “00” indicates a receive direction only.

Clause 56: The method of clause 52, wherein the packet header extension comprises the RTP header extension for dynamically changing traffic characteristics, and wherein the RTP header extension for dynamically changing traffic characteristics includes a first bit having a value indicating whether an expedited transfer indication is true, and a second bit having a value indicating a traffic direction for the expedited transfer indication.

Clause 57: The method of clause 56, wherein a value of true for the second bit indicates both a send direction and a receive direction, and a value of false for the second bit indicates a receive direction only.

Clause 58: The method of clause 52, wherein the packet header extension comprises the RTP header extension for dynamically changing traffic characteristics, and wherein the RTP header extension for dynamically changing traffic characteristics includes two bits having a value indicating a traffic direction for an expedited transfer indication, wherein a value of “01” indicates send direction only, a value of “10” indicates a receive direction only, a value of “11” indicates both send and receive directions, and a value of “00” indicates a receive direction only.

Clause 59: The method of clause 44, wherein the packet header extension comprises a QUIC header extension, and wherein negotiating the use of the QUIC header extension comprises negotiating the use of the QUIC header extension in-band using negotiation frames in session setup.

Clause 60: The method of clause 59, wherein the negotiation frames comprise one or more of an initial packet, a handshake packet, or a 1-RTT packet.

Clause 61: The method of clause 59, wherein the negotiation frames include: a QUIC header extension request frame including a header extension identifier for the QUIC header extension and a definition of an extension corresponding to the QUIC header extension; and a QUIC header extension response frame including data confirming support for the QUIC header extension.

Clause 62: The method of clause 59, wherein the negotiation frames are encrypted.

Clause 63: The method of clause 59, wherein the negotiation frames are not encrypted.

Clause 64: The method of clause 44, wherein the packet header extension comprises a QUIC header extension, and wherein negotiating the use of the QUIC header extension comprises exchanging transport parameters indicating unilateral declarations of support for QUIC header extensions during a handshake phase of QUIC.

Clause 65: The method of clause 44, wherein the packet header extension comprises a QUIC header extension, and wherein negotiating the use of the QUIC header extension comprises negotiating the use of the QUIC header extension out-of-band through exchanging metadata in an assistance protocol.

Clause 66: The method of clause 65, wherein the assistance protocol comprises session description protocol (SDP).

Clause 67: A method of exchanging data via a network, the method comprising exchanging a packet of a media communication session, the packet including a packet header extension, the packet header extension including data representing quality of service (QoS) requirements for the media communication session.

Clause 68: The method of clause 67, wherein the QoS requirements include one or more of a desired bitrate for the media communication session, a desired change in delay for the media communication session, a desired packet error rate for the media communication session, a desired change in the packet error rate, or a desired change in an overall QoS level.

Clause 69: The method of clause 68, wherein the QoS requirements include at least one of the desired change in the delay for the media communication session or the desired change in the packet error rate, and wherein the QoS requirements further include data representative of a traffic direction to which the desired change applies.

Clause 70: The method of clause 69, wherein the traffic direction comprises one of a send direction, a receive direction, or both the send and receive directions.

Clause 71: The method of any of clauses 68-70, wherein the QoS requirements include at least one of the desired change in delay or the desired change in the packet error rate, and wherein the desired change is specified in at least one of no amount, a relative amount, or an absolute amount.

Clause 72: The method of any of clauses 67-71, wherein exchanging comprises receiving, by a network device, the method further comprising: monitoring actual end-to-end performance metrics for the media communication session; and comparing the actual end-to-end performance metrics with target end-to-end performance metrics based on the QoS requirements.

Clause 73: The method of any of clauses 67-72, wherein exchanging comprises receiving, by a network device, the method further comprising determining changes to a user experience of the media communication session based on the QoS requirements.

Clause 74: The method of any of clauses 67-71, wherein exchanging comprises sending, by a media application provider (AP) device or by a media application server (AS) device.

Clause 75: The method of any of clauses 67-74, further comprising negotiating use of the packet header extension prior to exchanging the packet including the packet header extension.

Clause 76: The method of clause 75, wherein the packet header extension comprises a real-time transport protocol (RTP) header extension.

Clause 77: The method of clause 76, wherein negotiating the use of the RTP header extension comprises negotiating the use of the RTP header extension using session description protocol (SDP).

Clause 78: The method of clause 77, wherein negotiating the use of the RTP header extension comprises sending or receiving an SDP message, the SDP message comprising one of an SDP Offer message or an SDP Answer message, the SDP message including RTP negotiation data formatted according to: extensionname=“urn:3gpp:expedited transfer:rel-19”; extensionattributes=[format][SP “bitrate-abs”] [SP “delay-delta” SP][SP “direction”]; format =“short”/“long”, wherein “format” indicates whether the RTP header extension has a short format or a long format, wherein presence or absence of bitrate-abs indicates presence or absence of a field for a desired bitrate with an absolute amount in the RTP header extension, wherein presence or absence of delay-delta indicates presence or absence of a field for a desired change in delay in the RTP header extension, and wherein presence or absence of direction indicates presence or absence of a field for a traffic direction in the RTP header extension.

Clause 79: The method of any of clauses 67-78, wherein the packet header extension comprises a real-time transport protocol (RTP) header extension including fields for one or more of a desired bitrate, a desired decrease in delay, a multiplier value for a desired packet error rate, or a traffic direction.

Clause 80: The method of clause 79, wherein the field for the desired bitrate is 18 bits, the field for the desired decrease in delay is 6 bits, the field for the multiplier value is 6 bits, and the field for the direction is 2 bits.

Clause 81: The method of any of clauses 79 and 80, wherein the RTP header extension conforms to a one-byte format including a hex 0×BE value, a hex 0×DE value, a length field having 16 bits, an identifier (ID) field having 4 bits, and an L=2 field having 4 bits.

Clause 82: The method of any of clauses 79 and 80, wherein the RTP header extension conforms to a two-byte format including a hex 0×100 field having 12 bits, an appbits field having 4 bits, a length field having 16 bits, an identifier (ID) field having 8 bits, and an L=3 field having 8 bits.

Clause 83: The method of any of clauses 67-78, wherein the packet header extension comprises one of a real-time transport protocol (RTP) header extension for protocol data unit (PDU) set marking or an RTP header extension for dynamically changing traffic characteristics.

Clause 84: The method of clause 83, wherein the packet header extension comprises the RTP header extension for PDU set marking, and wherein the RTP header extension for PDU set marking includes a first bit having a value indicating whether an expedited transfer indication is true.

Clause 85: The method of clause 84, wherein the RTP header extension for PDU Set marking includes a second bit having a value indicating a traffic direction for the expedited transfer indication.

Clause 86: The method of clause 85, wherein a value of true for the second bit indicates both a send direction and a receive direction, and a value of false for the second bit indicates a receive direction only.

Clause 87: The method of clause 83, wherein the packet header extension comprises the RTP header extension for PDU set marking, and wherein the RTP header extension for PDU set marking includes two bits having a value indicating a traffic direction for an expedited transfer indication, wherein a value of “01” indicates send direction only, a value of “10” indicates a receive direction only, a value of “11” indicates both send and receive directions, and a value of “00” indicates a receive direction only.

Clause 88: The method of clause 83, wherein the packet header extension comprises the RTP header extension for dynamically changing traffic characteristics, and wherein the RTP header extension for dynamically changing traffic characteristics includes a first bit having a value indicating whether an expedited transfer indication is true.

Clause 89: The method of clause 88, wherein the RTP header extension includes a second bit having a value indicating a traffic direction for the expedited transfer indication.

Clause 90: The method of clause 89, wherein a value of true for the second bit indicates both a send direction and a receive direction, and a value of false for the second bit indicates a receive direction only.

Clause 91: The method of clause 83, wherein the packet header extension comprises the RTP header extension for dynamically changing traffic characteristics, and wherein the RTP header extension for dynamically changing traffic characteristics includes two bits having a value indicating a traffic direction for an expedited transfer indication, wherein a value of “01” indicates send direction only, a value of “10” indicates a receive direction only, a value of “11” indicates both send and receive directions, and a value of “00” indicates a receive direction only.

Clause 92: The method of clause 75, wherein the packet header extension comprises a QUIC header extension, and wherein negotiating the use of the QUIC header extension comprises negotiating the use of the QUIC header extension in-band using negotiation frames in session setup.

Clause 93: The method of clause 92, wherein the negotiation frames comprise one or more of an initial packet, a handshake packet, or a 1-RTT packet.

Clause 94: The method of any of clauses 92 and 93, wherein the negotiation frames include: a QUIC header extension request frame including a header extension identifier for the QUIC header extension and a definition of an extension corresponding to the QUIC header extension; and a QUIC header extension response frame including data confirming support for the QUIC header extension.

Clause 95: The method of any of clauses 92-94, wherein the negotiation frames are encrypted.

Clause 96: The method of any of clauses 92-94, wherein the negotiation frames are not encrypted.

Clause 97: The method of clause 75, wherein the packet header extension comprises a QUIC header extension, and wherein negotiating the use of the QUIC header extension comprises exchanging transport parameters indicating unilateral declarations of support for QUIC header extensions during a handshake phase of QUIC.

Clause 98: The method of clause 75, wherein the packet header extension comprises a QUIC header extension, and wherein negotiating the use of the QUIC header extension comprises negotiating the use of the QUIC header extension out-of-band through exchanging metadata in an assistance protocol.

Clause 99: The method of clause 98, wherein the assistance protocol comprises session description protocol (SDP).

Clause 100: A device for receiving data via a network, the device comprising one or more means for performing the method of any of clauses 1-99.

Clause 101: The device of clause 100, wherein the one or more means comprise a memory and a processing system implemented in circuitry.

Clause 102: The device of clause 100, wherein the device comprises at least one of: an integrated circuit; a microprocessor; or a wireless communication device.

Clause 103: A device for exchanging data via a network, the device comprising means for exchanging a packet of a media communication session, the packet including a packet header extension, the packet header extension including quality of service (QoS) requirements for the media communication session.

Clause 104: A method of receiving data via a network, the method comprising: extracting data representing quality of service (QoS) requirements for a packet of a media communication session from a packet header extension of the packet; monitoring at least one performance metric of the media communication session based on the QoS requirements to determine a monitored performance metric; comparing the monitored performance metric to the QoS requirements to generate feedback data; and sending the feedback data to a source device that sent the packet as part of the media communication session.

Clause 105: The method of clause 104, wherein the QoS requirements include one or more of a target bitrate for the media communication session, a target change in delay for the media communication session, a target packet error rate for the media communication session, a target change in the packet error rate, or a target change in an overall QoS level.

Clause 106: The method of clause 105, wherein the QoS requirements include at least one of the target change in the delay for the media communication session or the target change in the packet error rate, and wherein the QoS requirements further include data representative of a traffic direction to which the target change applies.

Clause 107: The method of clause 106, wherein the traffic direction comprises one of a send direction, a receive direction, or both the send direction and the receive directions.

Clause 108: The method of any of clauses 105-107, wherein the QoS requirements include at least one of the target change in delay or the target change in the packet error rate, and wherein the target change is specified in at least one of no amount, a relative amount, or an absolute amount.

Clause 109: The method of any of clauses 104-108, wherein the packet header extension comprises a real-time transport protocol (RTP) header extension including fields for one or more of a target bitrate, a target decrease in delay, a multiplier value for a target packet error rate, or a traffic direction.

Clause 110: The method of any of clauses 104-108, wherein the packet header extension comprises one of a real-time transport protocol (RTP) header extension for protocol data unit (PDU) set marking or an RTP header extension for dynamically changing traffic characteristics.

Clause 111: The method of any of clauses 104-108, further comprising negotiating use of the packet header extension prior to receiving the packet including the packet header extension.

Clause 112: The method of clause 111, wherein the packet header extension comprises a real-time transport protocol (RTP) header extension.

Clause 113: The method of clause 112, wherein negotiating the use of the RTP header extension comprises negotiating the use of the RTP header extension using session description protocol (SDP).

Clause 114: The method of clause 113, wherein negotiating the use of the RTP header extension comprises sending or receiving an SDP message, the SDP message comprising one of an SDP Offer message or an SDP Answer message, the SDP message including RTP negotiation data formatted according to: extensionname=“urn:3gpp:expedited transfer:rel-19”; extensionattributes=[format][SP “bitrate-abs”] [SP “delay-delta” SP][SP “direction”]; format=“short”/“long”, wherein “format” indicates whether the RTP header extension has a short format or a long format, wherein presence or absence of bitrate-abs indicates presence or absence of a field for a target bitrate with an absolute amount in the RTP header extension, wherein presence or absence of delay-delta indicates presence or absence of a field for a target change in delay in the RTP header extension, and wherein presence or absence of direction indicates presence or absence of a field for a traffic direction in the RTP header extension.

Clause 115: The method of clause 111, wherein the packet header extension comprises a QUIC header extension, and wherein negotiating the use of the QUIC header extension comprises negotiating the use of the QUIC header extension in-band using negotiation frames in session setup.

Clause 116: The method of clause 111, wherein the packet header extension comprises a QUIC header extension, and wherein negotiating the use of the QUIC header extension comprises exchanging transport parameters indicating unilateral declarations of support for QUIC header extensions during a handshake phase of QUIC.

Clause 117: The method of clause 111, wherein the packet header extension comprises a QUIC header extension, and wherein negotiating the use of the QUIC header extension comprises negotiating the use of the QUIC header extension out-of-band through exchanging metadata in an assistance protocol.

Clause 118: The method of clause 117, wherein the assistance protocol comprises session description protocol (SDP).

Clause 119: A device for receiving data via a network, the device comprising: a memory configured to store data; and a processing system implemented in circuitry and configured to: extract data representing quality of service (QoS) requirements for a packet of a media communication session from a packet header extension of the packet; monitor at least one performance metric of the media communication session based on the QoS requirements to determine a monitored performance metric; compare the monitored performance metric to the QoS requirements to generate feedback data; and send the feedback data to a source device that sent the packet as part of the media communication session.

Clause 120: The device of clause 119, wherein the QoS requirements include one or more of a target bitrate for the media communication session, a target change in delay for the media communication session, a target packet error rate for the media communication session, a target change in the packet error rate, or a target change in an overall QoS level.

Clause 121: The device of clause 119, wherein the packet header extension comprises a real-time transport protocol (RTP) header extension including fields for one or more of a target bitrate, a target decrease in delay, a multiplier value for a target packet error rate, or a traffic direction.

Clause 122: The device of clause 119, wherein the processing system is further configured to negotiate use of the packet header extension prior to receiving the packet including the packet header extension.

Clause 123: The device of clause 122, wherein the packet header extension comprises a QUIC header extension, and wherein negotiating the use of the QUIC header extension comprises negotiating the use of the QUIC header extension in-band using negotiation frames in session setup.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of receiving data via a network, the method comprising:
extracting data representing quality of service (QoS) requirements for a packet of a media communication session from a packet header extension of the packet;
monitoring at least one performance metric of the media communication session based on the QoS requirements to determine a monitored performance metric;
comparing the monitored performance metric to the QoS requirements to generate feedback data; and
sending the feedback data to a source device that sent the packet as part of the media communication session.

2. The method of claim 1, wherein the QoS requirements include one or more of a target bitrate for the media communication session, a target change in delay for the media communication session, a target packet error rate for the media communication session, a target change in a packet error rate, or a target change in an overall QoS level.

3. The method of claim 2, wherein the QoS requirements include at least one of the target change in the delay for the media communication session or the target change in the packet error rate, and wherein the QoS requirements further include data representative of a traffic direction to which the target change in delay or the target change in the packet error rate applies.

4. The method of claim 3, wherein the traffic direction comprises one of a send direction, a receive direction, or both the send direction and the receive directions.

5. The method of claim 2, wherein the QoS requirements include at least one of the target change in delay or the target change in the packet error rate, and wherein the target change in delay or the target change in the packet error rate is specified in at least one of no amount, a relative amount, or an absolute amount.

6. The method of claim 1, wherein the packet header extension comprises a real-time transport protocol (RTP) header extension including fields for one or more of a target bitrate, a target decrease in delay, a multiplier value for a target packet error rate, or a traffic direction.

7. The method of claim 1, wherein the packet header extension comprises one of a real-time transport protocol (RTP) header extension for protocol data unit (PDU) set marking or an RTP header extension for dynamically changing traffic characteristics.

8. The method of claim 1, further comprising negotiating use of the packet header extension prior to receiving the packet including the packet header extension.

9. The method of claim 8, wherein the packet header extension comprises a real-time transport protocol (RTP) header extension.

10. The method of claim 9, wherein negotiating the use of the RTP header extension comprises negotiating the use of the RTP header extension using session description protocol (SDP).

11. The method of claim 10, wherein negotiating the use of the RTP header extension comprises sending or receiving an SDP message, the SDP message comprising one of an SDP Offer message or an SDP Answer message, the SDP message including RTP negotiation data formatted according to:
extensionname=“urn:3gpp:expedited transfer:rel-19”;
extensionattributes=[format][SP “bitrate-abs”][SP “delay-delta” SP][SP “direction”];
format=“short”/“long”,
wherein “format” indicates whether the RTP header extension has a short format or a long format,
wherein presence or absence of bitrate-abs indicates presence or absence of a field for a target bitrate with an absolute amount in the RTP header extension,
wherein presence or absence of delay-delta indicates presence or absence of a field for a target change in delay in the RTP header extension, and
wherein presence or absence of direction indicates presence or absence of a field for a traffic direction in the RTP header extension.

12. The method of claim 8, wherein the packet header extension comprises a QUIC header extension, and wherein negotiating the use of the QUIC header extension comprises negotiating the use of the QUIC header extension in-band using negotiation frames in session setup.

13. The method of claim 8, wherein the packet header extension comprises a QUIC header extension, and wherein negotiating the use of the QUIC header extension comprises exchanging transport parameters indicating unilateral declarations of support for QUIC header extensions during a handshake phase of QUIC.

14. The method of claim 8, wherein the packet header extension comprises a QUIC header extension, and wherein negotiating the use of the QUIC header extension comprises negotiating the use of the QUIC header extension out-of-band through exchanging metadata in an assistance protocol.

15. The method of claim 14, wherein the assistance protocol comprises session description protocol (SDP).

16. A device for receiving data via a network, the device comprising:
a memory configured to store data; and
a processing system implemented in circuitry and configured to:
extract data representing quality of service (QoS) requirements for a packet of a media communication session from a packet header extension of the packet;
monitor at least one performance metric of the media communication session based on the QoS requirements to determine a monitored performance metric;
compare the monitored performance metric to the QoS requirements to generate feedback data; and
send the feedback data to a source device that sent the packet as part of the media communication session.

17. The device of claim 16, wherein the QoS requirements include one or more of a target bitrate for the media communication session, a target change in delay for the media communication session, a target packet error rate for the media communication session, a target change in a packet error rate, or a target change in an overall QoS level.

18. The device of claim 16, wherein the packet header extension comprises a real-time transport protocol (RTP) header extension including fields for one or more of a target bitrate, a target decrease in delay, a multiplier value for a target packet error rate, or a traffic direction.

19. The device of claim 16, wherein the processing system is further configured to negotiate use of the packet header extension prior to receiving the packet including the packet header extension.

20. The device of claim 19, wherein the packet header extension comprises a QUIC header extension, and wherein negotiating the use of the QUIC header extension comprises negotiating the use of the QUIC header extension in-band using negotiation frames in session setup.
